(19) United States
(12) Patent Application Publication
(10) Pub. No.: US 2024/0224869 A9
(43) Pub. Date: Jul. 11, 2024

(54) VEHICLE

(71) Applicant: HONDA MOTOR CO., LTD., Tokyo (JP)

(72) Inventor: Kentaro Sugimura, Wako-shi, Saitama-ken (JP)

(21) Appl. No.: 18/546,649

(22) PCT Filed: Feb. 18, 2021
(86) PCT No.: PCT/JP2021/006130

§ 371 Date: Aug. 16, 2023

(51) Int. Cl. A01D 69/02; A01D 34/78; B60K 1/04

(52) U.S. Cl. CPC A01D 69/02; A01D 34/78; B60K 1/04; A01D 2101/00

(57) ABSTRACT

A vehicle includes front wheels, rear wheels, and a battery holder which is capable of storing and holding detachable batteries. At least a part of the battery holder is provided above the front wheels. Opening portions, which are used to attach and detach the detachable batteries to and from the battery holder, are provided to an upper portion of the battery holder. The battery holder is arranged inclined with respect to the vertical direction so that at least a part of the opening portions is positioned forward with respect to a lower portion of the battery holder.

### TECHNICAL FIELD

The present invention relates to a vehicle including a battery holder capable of accommodating an attachable and detachable battery.

### BACKGROUND ART

An electric vehicle (riding lawn mower) has been conventionally known (see, for example, JP 2018-102196 A). In the riding lawn mower disclosed in JP 2018-102196 A, a battery for supplying electric power to a motor, which is a rotary drive source of a work section (a cutting blade), is mounted.

### SUMMARY OF THE INVENTION

In order to improve the convenience of the electric vehicle, it is conceivable to employ an attachable and detachable battery. Since the attachable and detachable battery is assumed to be frequently attached to and detached from the vehicle body manually, for example, it is required that the attachable and detachable battery can be easily attached and detached.

An object of the present invention is to provide a vehicle in which an attachable and detachable battery can be easily attached and detached.

According to an aspect of the present invention, there is provided a vehicle comprising a front wheel, a rear wheel, and a battery holder configured to accommodate and hold an attachable and detachable battery, wherein at least a part of the battery holder is provided above the front wheel, an opening configured to allow the attachable and detachable battery to be attached to and detached from the battery holder is provided in an upper portion of the battery holder, and the battery holder is disposed so as to be inclined with respect to a vertical direction in a manner so that at least a part of the opening is located more forward than a lower portion of the battery holder.

According to the vehicle of the present invention, the attachable and detachable battery can be easily attached and detached.

### BRIEF DESCRIPTION OF DRAWINGS

FIG. 1 is a perspective view of a vehicle (riding lawn mower) according to an embodiment of the present invention;

FIG. 2 is a schematic side view of the riding lawn mower shown in FIG. 1; and

FIG. 3 is a perspective view of a battery holder.

### DETAILED DESCRIPTION OF THE INVENTION

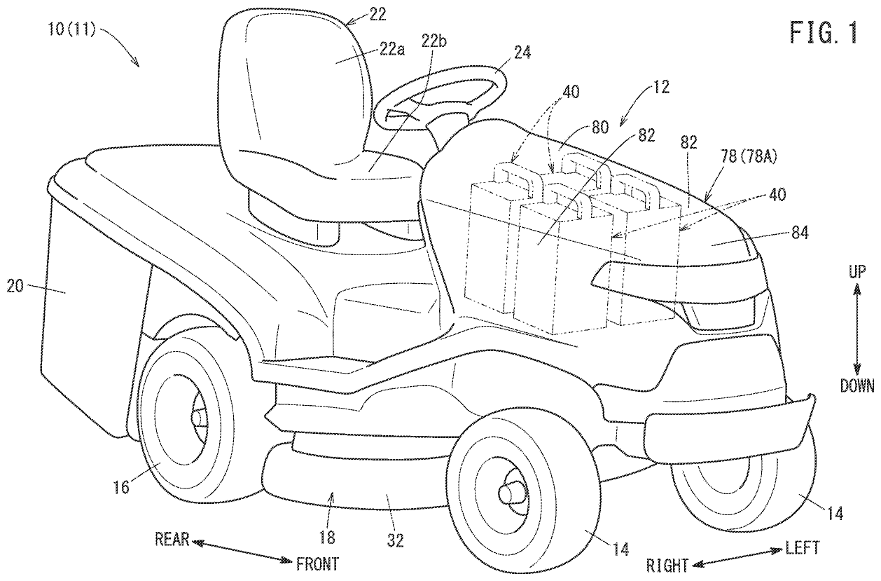

As shown in FIG. 1, a vehicle 10 according to an embodiment of the present invention includes a vehicle body 12 on which an occupant (an operator) can ride. In the present embodiment, the vehicle 10 is a riding lawn mower 11. A pair of left and right front wheels 14 are provided at a lower portion of a front portion of the vehicle body 12. A pair of left and right rear wheels 16 are provided at a lower portion of a rear portion of the vehicle body 12. A work section 18 for cutting grass (lawn grass) is provided at a lower portion of the vehicle body 12, between the front wheels 14 and the rear wheels 16. A grass clippings container 20 (a grass bag) is attached to a rear end portion of the vehicle body 12. The grass clippings container 20 is attachable to and detachable from the rear end portion of the vehicle body 12.

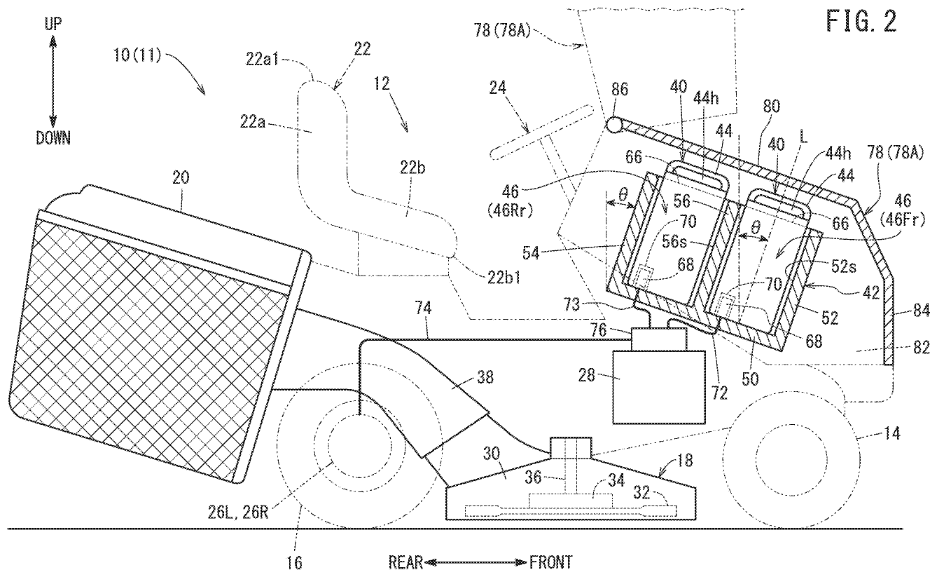

As shown in FIG. 2, a seat 22 on which the occupant is seated is provided at the rear portion of the vehicle body 12 and above the rear wheels 16 (specifically, at a position where the rear wheels 16 at least partially overlap the seat 22 in plan view). The seat 22 includes a backrest 22a (seat back) and a seat bottom 22b (seat cushion). The left and right front wheels 14 are supported by the vehicle body 12 so as to be steerable via a steering mechanism (not shown). A steering wheel 24 connected to the steering mechanism is disposed in front of the seat 22 in an upper portion of the vehicle body 12.

The vehicle body 12 includes, as traveling drive sources, a left travel motor 26L that drives the left rear wheel 16 and a right travel motor 26R that drives the right rear wheel 16. As another mode, the vehicle body 12 may include, as a traveling drive source, one travel motor that drives both the left and right rear wheels 16.

The vehicle body 12 includes a work motor 28 that drives the work section 18 as a working drive source. In another mode, a single motor serving as both the working drive source and the traveling drive source may be provided. Further, if at least one of the traveling drive source or the working drive source is a motor, the other thereof may be an internal combustion engine.

The work section 18 includes a housing 30 that opens downward, and a pair of left and right cutting blades 32 rotatably provided inside the housing 30. Each cutting blade 32 is a linearly extending blade, and is connected to a lower end portion of a rotation shaft 36 via a blade holder 34. A power transmission mechanism (not shown) that transmits power of the work motor 28 to the rotation shaft 36 is provided between the work motor 28 and the rotation shaft 36.

The vehicle body 12 is provided with a conveying passage 38 (a duct) extending rearward from the work section 18 and connected to the grass clippings container 20. The conveying passage 38 forms a grass clippings conveying passage extending between the housing 30 and the grass clippings container 20. The conveying passage 38 is provided so as to extend at least partially, preferably entirely, to a side of the work section 18 different from the side on which a battery holder 42 is disposed (specifically, in a direction toward an opposite side of the work section 18 to the side on which the battery holder 42 is disposed, that is, rearward). It should be noted that the riding lawn mower 11 may be a mulching lawn mower in which the grass clippings container 20 and the conveying passage 38 are not provided and the grass clippings are dropped below the cutting blades 32 and spread over the lawn, or a side discharge lawn mower in which the grass clippings container 20 and the conveying passage 38 are not provided and the grass clippings are blown out sideways from the housing 30.

The vehicle body 12 includes the battery holder 42 that can accommodate and hold an attachable and detachable battery 40 (hereinafter also referred to as a “battery 40”). The battery holder 42 is fixed to an appropriate portion (such as a frame) of the vehicle body 12. The battery 40 has a substantially rectangular parallelepiped shape as shown in FIG. 1 of JP 2019-068720 A. A grip portion 44 to be gripped by a user is provided at an upper end portion of the battery 40. The grip portion 44 is provided with a finger insertion hole portion 44h into which the user's fingers are inserted.

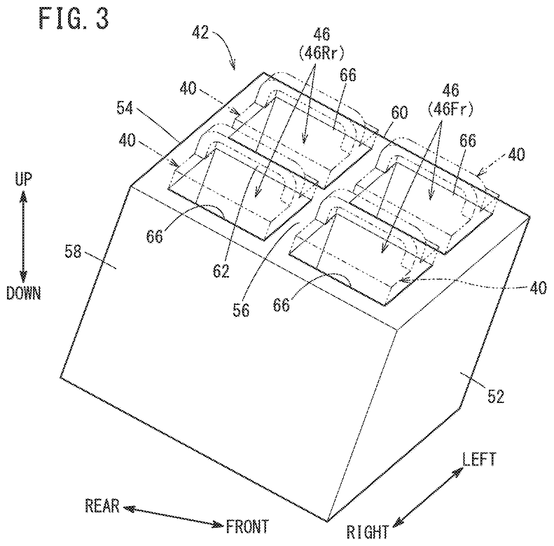

As shown in FIG. 3, in the present embodiment, the battery holder 42 is configured to be able to accommodate and hold a total of four batteries 40, two in the front-rear direction and two in the left-right direction. The four batteries 40 have the same shape. That is, the four batteries 40 have the same height, width, and depth.

The battery holder 42 is a case including four accommodating portions 46 for accommodating the four batteries 40, respectively. Each of the accommodating portions 46 is a recessed portion that forms an accommodation space capable of accommodating the battery 40. Specifically, the battery holder 42 includes a pair of left and right front-side accommodating portions 46Fr, and a pair of left and right rear-side accommodating portions 46Rr.

As shown in FIG. 2, the battery holder 42 includes a bottom wall 50 forming a bottom portion of the battery holder 42, a front wall 52 protruding obliquely upward from a front end of the bottom wall 50, a rear wall 54 protruding obliquely upward from a rear end of the bottom wall 50, and a front-rear direction intermediate wall 56 formed between the front wall 52 and the rear wall 54, extending in the left-right direction, and separating the front-side accommodating portions 46Fr from the rear-side accommodating portions 46Rr. A rear surface 52s of the front wall 52 is a support surface that supports the front surfaces of the batteries 40 accommodated in the front-side accommodating portions 46Fr. A rear surface 56s of the front-rear direction intermediate wall 56 is a support surface that supports the front surfaces of the batteries 40 accommodated in the rear-side accommodating portions 46Rr. Each of the front wall 52, the rear wall 54, and the front-rear direction intermediate wall 56 extends upward so as to be inclined forward. Therefore, an upper end portion of the front wall 52 is located more forward than a lower end portion of the front wall 52 (the front end of the bottom wall 50). An upper end portion of the rear wall 54 is located more forward than a lower end portion of the rear wall 54. An upper end portion of the front-rear direction intermediate wall 56 is located more forward than a lower end portion of the front-rear direction intermediate wall 56. The front wall 52, the rear wall 54, and the front-rear direction intermediate wall 56 extend parallel to one another.

As shown in FIG. 3, the battery holder 42 includes a right wall 58 protruding upward from a right end of the bottom wall 50, a left wall 60 protruding upward from a left end of the bottom wall 50, and a left-right direction intermediate wall 62 formed between the right wall 58 and the left wall 60, extending in the front-rear direction, and separating the left front-side accommodating portion 46Fr and the left rear-side accommodating portion 46Rr from the right front-side accommodating portion 46Fr and the right rear-side accommodating portion 46Rr. The right wall 58, the left wall 60, and the left-right direction intermediate wall 62 extend parallel to one another. The bottom wall 50, the front wall 52, the rear wall 54, the front-rear direction intermediate wall 56, the right wall 58, the left wall 60, and the left-right direction intermediate wall 62 form the four front, rear, left, and right accommodating portions 46.

Openings 66 for attaching the batteries 40 to and detaching the batteries 40 from the battery holder 42 are provided in an upper portion of the battery holder 42. In the present embodiment, the battery holder 42 is provided with four openings 66 corresponding to the four accommodating portions 46, respectively. That is, in each accommodating portion 46, an upper end of the accommodating portion 46 forms the opening 66. Each opening 66 is inclined with respect to the horizontal direction such that a front end of the opening 66 is lower than a rear end of the opening 66.

As shown in FIG. 2, a lower portion (the bottom wall 50) of the battery holder 42 is provided with four device-side connectors 68 corresponding to the four accommodating portions 46, respectively. When each battery 40 is accommodated in (attached to) the accommodating portion 46, the device-side connector 68 is connected to a battery-side connector 70 provided at a bottom portion of the battery 40. In each accommodating portion 46, the device-side connector 68 is disposed more rearward than an axis L located at the center of the accommodating portion 46.

Note that the number of the batteries 40 that can be accommodated in the battery holder 42 is not limited to four. Therefore, the battery holder 42 may accommodate only one to three batteries 40. The battery holder 42 may be configured to accommodate five or more batteries 40.

A power drive unit (PDU) 76 electrically connected to the battery holder 42 via harnesses 72 and 73 is disposed below the battery holder 42. The power drive unit 76 is a control unit that converts DC power of the batteries 40 into AC power to control the work motor 28 and the left and right travel motors 26L and 26R. The power drive unit 76 is disposed on (fixed to) an upper portion of the work motor 28. The power drive unit 76 is electrically connected to the left and right travel motors 26L and 26R via a harness 74, and is electrically connected to the work motor 28 via a harness (not shown). The power drive unit 76, the work motor 28, and the left and right travel motors 26L and 26R are all electrical components that receive power supply from the batteries 40.

The vehicle body 12 includes an openable and closable covering portion 78 that covers the openings 66 of the battery holder 42. Specifically, the covering portion 78 is a hood (bonnet) 78A provided at the upper front portion of the vehicle body 12. The hood 78A includes an upper panel portion 80, left and right side panel portions 82 protruding downward from a left end and a right end of the upper panel portion 80, respectively, and a front panel portion 84 connected to a front end of the upper panel portion 80 and front ends of the left and right side panel portions 82. In a state in which the hood 78A is closed, the battery holder 42 is covered by the hood 78A from above, left, right, and front.

In a state in which the hood 78A is closed, the hood 78A covers the openings 66 of the front-side accommodating portions 46Fr and the rear-side accommodating portions 46Rr, and an upper surface of the hood 78A (an upper surface of the upper panel portion 80) is inclined downward toward the front side.

The hood 78A is supported at an appropriate portion (such as the frame) of the vehicle body 12 in a state in which an upper rear end of the hood 78A can pivot about a horizontal axis by a hinge 86. As a result, the hood 78A pivots upward and opens as shown by the imaginary line in FIG. 2. In a state in which the hood 78A is open, each opening 66 of the battery holder 42 is exposed to the outside of the vehicle body 12. Therefore, the user can attach and detach the battery 40 while standing in front of the vehicle body 12 (in front of the battery holder 42).

Note that the hood 78A may not be provided. In this case, as another mode of the covering portion 78, the battery holder 42 may be provided with an openable and closable lid member for covering the four openings 66 individually or collectively.

Next, a mutual positional relationship among the seat 22, the battery holder 42, the work section 18, the work motor 28, and the power drive unit 76 will be described.

The openings 66 of the battery holder 42 are disposed so as to overlap the seat 22 in the height direction (the vertical direction). Therefore, at least one opening 66 among the plurality of openings 66 or at least a part of the at least one opening 66 is located at a position lower than an upper end of the seat 22 (an upper end 22a1 of the backrest 22a) and higher than a lower end of the seat 22 (a lower end 22b1 of the seat bottom 22b). Note that in the present embodiment, all the openings 66 are disposed so as to overlap the seat 22 in the height direction (the vertical direction), but some or all of the openings 66 of the rear-side accommodating portions 46Rr may be disposed so as to overlap the seat 22 in the height direction, and some or all of the openings 66 of the front-side accommodating portions 46Fr may be disposed at lower positions than the seat 22 (at positions not overlapping the seat 22 in the height direction (the vertical direction)).

The battery holder 42 is disposed so as to be inclined forward with respect to the vertical direction such that at least a part of the openings 66 is located more forward than the lower portion of the battery holder 42 (specifically, the front end of the bottom wall 50). Therefore, the battery holder 42 is inclined forward by an angle θ with respect to the vertical direction (inclined forward as it extends upward). Since the battery holder 42 is inclined forward, the axis L of each accommodating portion 46 provided in the battery holder 42 is also inclined forward by the angle θ with respect to the vertical direction. The front-side accommodating portion 46Fr and the rear-side accommodating portion 46Rr are inclined forward with respect to the vertical direction at the same inclination angle.

The battery holder 42 is provided so as to be inclined such that the openings 66 are oriented in a direction (a direction inclined forward with respect to the vertical direction) different from the extending direction of the conveying passage 38 (a direction inclined rearward with respect to the vertical direction) with respect to the work section 18.

The angle θ is preferably 10° to 45°. By setting the angle θ within such an angle range, the battery 40 can be easily attached to and detached from the accommodating portion 46.

At least a part of the openings 66 of the battery holder 42 (at least one opening 66 among the plurality of openings 66 or at least a part of the at least one opening 66) is located more forward than the device-side connector 68. In the present embodiment, at least a front portion of the opening 66 of each front-side accommodating portion 46Fr is located more forward than the device-side connector 68 provided in the front-side accommodating portion 46Fr.

At least a part of the battery holder 42 (at least one opening 66 among the plurality of openings 66 or at least a part of the at least one opening 66) is provided above the front wheel 14. That is, at least a part of the battery holder 42 (at least one opening 66 among the plurality of openings 66 or at least a part of the at least one opening 66) and the front wheel 14 are disposed so as to overlap each other in the front-rear direction of the riding lawn mower 11 (so as to at least partially overlap each other in plan view). Specifically, the front-side accommodating portions 46Fr are provided above the front wheels 14.

At least a part of the battery holder 42 is disposed more forward than the work section 18 (more specifically, a front end of each cutting blade 32). In the present embodiment, a part of the battery holder 42 is disposed more forward than the work section 18, and the remaining part of the battery holder 42 is disposed so as to overlap the work section 18 in the front-rear direction of the riding lawn mower 11. Note that the entire battery holder 42 may be disposed more forward than the work section 18.

A part of the lower portion (at least a front portion of the lower portion) of the battery holder 42 is located forward of the electrical components (one or both of the work motor 28 and the power drive unit 76). Specifically, the front portion (specifically, the front portion including the front end of the bottom wall 50) of the lower portion (specifically, the lower portion including the bottom wall 50) of the forwardly inclined battery holder 42 is located more forward than the work motor 28 and the power drive unit 76. Further, the front portion (specifically, the front portion including the front end of the bottom wall 50) of the lower portion (specifically, the lower portion including the bottom wall 50) of the forwardly inclined battery holder 42 and the power drive unit 76 overlap each other in the up-down direction (the vertical direction). The front portion of the lower portion of the forwardly inclined battery holder 42 may overlap the work motor 28 in the up-down direction.

The rear-side accommodating portions 46Rr are disposed more rearward than the front-side accommodating portions 46Fr and above the electrical components (one or both of the work motor 28 and the power drive unit 76). That is, the rear-side accommodating portions 46Rr are disposed higher than the electrical components so as to overlap the electrical components in the front-rear direction of the riding lawn mower 11 (so as to at least partially overlap the electrical component in plan view). Further, the front-side accommodating portions 46Fr are disposed forward of the electrical components (one or both of the work motor 28 and the power drive unit 76).

At least a part of the electrical components (one or both of the work motor 28 and the power drive unit 76) is disposed more forward than the work section 18. At least a part of the battery holder 42 (specifically, a part of the openings 66) and at least a part of the electrical components are disposed more forward than and above the work section 18.

The present embodiment exhibits the following effects.

In the vehicle 10, the battery holder 42 is disposed close to the front of the vehicle body 12 (above the front wheels 14 in the present embodiment) and inclined forward. Therefore, when the battery 40 is attached or detached, the distance between the battery holder 42 and the user who performs work (attaches or detaches the battery 40) in front of the battery holder 42 can be shortened, and a part of the load of the battery 40 can be applied to the inner walls of the battery holder 42 (the inclined inner walls forming the accommodating portion 46). Therefore, the battery 40 can be easily attached to and detached from the battery holder 42. This effect is particularly remarkable in the case of a large work machine such as the riding lawn mower 11, in which the weight of the batteries 40 to be used is large.

The vehicle 10 is a work machine including the work section 18, and includes the openable and closable covering portion 78 that covers the openings 66. At least a part of the battery holder 42 (the opening 66 in the present embodiment) is disposed more forward than the work section 18 (the cutting blades 32 in the present embodiment). For this reason, when the vehicle 10 travels forward, it is possible to suppress the contamination of the batteries 40 due to grass, dust, or the like blown up by the work section 18 (the cutting blades 32). Further, the covering portion 78 of the battery holder 42 is not required to have high sealing performance. Therefore, the configuration can be simplified.

The vehicle 10 (work machine) includes the electrical components (in the present embodiment, one or both of the work motor 28 and the power drive unit 76) electrically connected to the battery holder 42, and at least a part of the electrical component is disposed more forward than the work section 18 (in the present embodiment, the cutting blades 32). With this configuration, it is possible to suppress the contamination of the electrical components due to dust or the like generated by the work section 18.

The work section 18 includes the cutting blades 32 for cutting the grass, and at least a part of the battery holder 42 (in the present embodiment, the opening 66) and at least a part of the electrical components are disposed more forward and higher than the work section 18 (in the present embodiment, the cutting blades 32). With this configuration, even when the grass having a larger mass than dust flies, it is possible to suppress scattering of the grass to the electrical components and the batteries 40 in the battery holder 42 since the battery holder 42 and the electrical components are disposed forward of and above the work section 18.

The vehicle 10 (the work machine) includes the conveying passage 38 connected to the work section 18, and the conveying passage 38 is provided so as to extend to a side of the work section 18 different from the side on which the battery holder 42 is disposed (specifically, in a direction toward an opposite side of the work section 18 to the side on which the battery holder 42 is disposed, that is, rearward). With this configuration, it is possible to further suppress the contamination of the batteries 40 in the battery holder 42 due to dust or the like generated by the work section 18.

The battery holder 42 is provided so as to be inclined such that the openings 66 are oriented in a direction (specifically, a direction inclined forward with respect to the vertical direction) different from the extending direction of the conveying passage 38 (specifically, a direction inclined rearward with respect to the vertical direction), with respect to the work section 18. With this configuration, it is possible to further suppress the contamination of the batteries 40 in the battery holder 42 due to dust or the like generated by the work section 18.

The openings 66 of the battery holder 42 are disposed so as to overlap, in the height direction, the seat 22 provided above the rear wheels 16, and therefore, when the battery 40, which is a relatively heavy object, is attached or detached, the amount of user's bending at the waist can be reduced to reduce the burden on the user. Therefore, the attachability and detachability of the battery 40 can be improved. In addition, when the riding lawn mower 11 is in use (during work), since the batteries 40, which are relatively heavy objects, are present at a location different from the seat 22 (a location more forward than the rear wheels 16), the load is distributed in the front-rear direction. Therefore, the concentration of the load on the rear wheels 16 is avoided, and it is possible to prevent the grass from being excessively laid down by the rear wheels 16 and the appearance thereof from being impaired.

The vehicle 10 includes the electrical components (in the present embodiment, one or both of the work motor 28 and the power drive unit 76) disposed below the rear portion of the battery holder 42 and connected to the battery holder 42 via the harnesses 72 and 73, and a part (in the present embodiment, the front portion including the front end of the bottom wall 50) of the lower portion (in the present embodiment, the lower portion including the bottom wall 50) of the battery holder 42 is located forward of the electrical components. With this configuration, since the battery holder 42 and the electrical components are disposed close to each other, it is possible to shorten the harnesses 72 and 73 that connect the battery holder 42 and the electrical components. In addition, it is possible to achieve both the forward inclination arrangement of the battery holder 42 and a compact device layout.

At least a part of the openings 66 of the battery holder 42 is located more forward than the device-side connector 68. With this configuration, since the battery holder 42 and the electrical components are disposed close to each other, it is possible to shorten the harnesses 72 and 73 that connect the battery holder 42 and the electrical components. In addition, since at least a part of the openings 66 is disposed more forward than the device-side connector 68, it is possible to improve the attachability and detachability of the battery 40 from the front side of the vehicle body 12. Therefore, it is possible to achieve both shortening of the harnesses 72 and 73, and the attachability and detachability of the battery 40.

The rear-side accommodating portions 46Rr are disposed more rearward than the front-side accommodating portions 46Fr and above the electrical components, and the front-side accommodating portions 46Fr are disposed forward of the electrical components. In a state in which the covering portion 78 is closed, the covering portion 78 covers the openings 66 of the front-side accommodating portions 46Fr and the rear-side accommodating portions 46Rr, and the upper surface of the covering portion 78 is inclined downward toward the front side. Thus, the battery 40 accommodated in each front-side accommodating portion 46Fr and the battery 40 accommodated in each rear-side accommodating portion 46Rr have the same shape, the front-side accommodating portions 46Fr and the rear-side accommodating portions 46Rr are inclined forward, the rear-side accommodating portions 46Rr are provided above the electrical components, and the front-side accommodating portions 46Fr are provided forward of the electrical components. Therefore, the shape of the covering portion 78 can be set such that the height of the upper surface of the covering portion 78 gradually decreases toward the front side. For this reason, it is possible to reduce the resistance of the traveling wind from the front of the covering portion 78 and to reduce the influence at the time of contact with an obstacle or the like.

The above embodiment can be summarized as follows.

The above embodiment discloses the vehicle (10) including the front wheel (14), the rear wheel (16), and the battery holder (42) configured to accommodate and hold the attachable and detachable battery (40), wherein at least a part of the battery holder is provided above the front wheel, the opening (66) configured to allow the attachable and detachable battery to be attached to and detached from the battery holder is provided in the upper portion of the battery holder, and the battery holder is disposed so as to be inclined with respect to the vertical direction in a manner so that at least a part of the opening is located more forward than the lower portion of the battery holder.

The vehicle is a work machine including the work section (18), the vehicle further includes the covering portion (78) configured to be openable and closable and to cover the opening, and at least a part of the battery holder is disposed more forward than the work section.

The vehicle further includes the electrical component electrically connected to the battery holder, and at least a part of the electrical component is disposed more forward than the work section.

The work section includes the cutting blade (32) configured to cut grass, and at least a part of the battery holder and at least a part of the electrical component are disposed more forward and higher than the work section.

The vehicle further includes the conveying passage (38) connected to the work section, and the conveying passage is provided so as to extend to a side of the work section different from a side on which the battery holder is disposed.

The battery holder is provided so as to be inclined in a manner so that the opening is oriented in a direction different from an extending direction of the conveying passage, with respect to the work section.

The vehicle is the riding lawn mower (11) in which the seat (22) for the occupant is disposed above the rear wheel, and the opening of the battery holder is disposed so as to overlap the seat in the height direction.

The vehicle further includes the electrical component disposed below the rear portion of the battery holder and connected to the battery holder via the harness (72, 73), and a part of the lower portion of the battery holder is located forward of the electrical component.

The vehicle further includes the electrical component disposed below the rear portion of the battery holder and connected to the battery holder via the harness (72, 73), the device-side connector (68) configured to be electrically connected to the attachable and detachable battery is provided at the bottom portion of the battery holder, and at least a part of the opening of the battery holder is located more forward than the device-side connector.

The vehicle further includes: the covering portion (78) configured to be openable and closable and to cover the opening; and the electrical component disposed below the rear portion of the battery holder and connected to the battery holder via the harness (72, 73), the battery holder includes the front-side accommodating portion (46Fr) configured to accommodate a first battery that is the attachable and detachable battery, and the rear-side accommodating portion (46Rr) configured to accommodate a second battery that is another attachable and detachable battery having the same shape as the first battery, the front-side accommodating portion and the rear-side accommodating portion are inclined forward with respect to the vertical direction at the same inclination angle, the rear-side accommodating portion is disposed more rearward than the front-side accommodating portion and above the electrical component, the front-side accommodating portion is disposed forward of the electrical component, and in a state in which the covering portion is closed, the covering portion covers the opening of each of the front-side accommodating portion and the rear-side accommodating portion, and the upper surface of the covering portion is inclined downward toward the front side.

The vehicle further includes the electrical component disposed below the rear portion of the battery holder and connected to the battery holder via the harness (72, 73), the battery holder includes the front-side accommodating portion (46Fr) configured to accommodate a first battery that is the attachable and detachable battery, and the rear-side accommodating portion (46Rr) configured to accommodate a second battery that is another attachable and detachable battery having the same shape as the first battery, the front-side accommodating portion and the rear-side accommodating portion are inclined forward with respect to the vertical direction at the same inclination angle, the rear-side accommodating portion is disposed more rearward than the front-side accommodating portion and above the electrical component, the front-side accommodating portion is disposed forward of the electrical component, and in a state in which the covering portion is closed, the covering portion covers the opening of each of the front-side accommodating portion and the rear-side accommodating portion, and the upper surface of the covering portion is inclined downward toward the front side.

The present invention is not limited to the above disclosure, and various modifications are possible without departing from the essence and gist of the present invention. In the present embodiment, a riding lawn mower is illustrated as an example of the vehicle, but the vehicle may be a passenger car or a commercial car that does not include the work section. Further, a lawn mower is illustrated as an example of the work machine, but the work machine may be a cleaning vehicle that includes a road surface cleaning section.

1. A vehicle comprising a front wheel, a rear wheel, and a battery holder configured to accommodate and hold an attachable and detachable battery,
wherein at least a part of the battery holder is provided above the front wheel,
an opening configured to allow the attachable and detachable battery to be attached to and detached from the battery holder is provided in an upper portion of the battery holder, and
the battery holder is disposed so as to be inclined with respect to a vertical direction in a manner so that at least a part of the opening is located more forward than a lower portion of the battery holder.

2. The vehicle according to claim 1, wherein
the vehicle is a work machine including a work section,
the vehicle further comprises a covering portion configured to be openable and closable and to cover the opening, and
at least a part of the battery holder is disposed more forward than the work section.

3. The vehicle according to claim 2, further comprising an electrical component electrically connected to the battery holder, wherein
at least a part of the electrical component is disposed more forward than the work section.

4. The vehicle according to claim 3, wherein
the work section includes a cutting blade configured to cut grass, and
at least a part of the battery holder and at least a part of the electrical component are disposed more forward than and above the work section.

5. The vehicle according to claim 2, further comprising a conveying passage connected to the work section, wherein
the conveying passage is provided so as to extend to a side of the work section different from a side on which the battery holder is disposed.

6. The vehicle according to claim 5, wherein
the battery holder is provided so as to be inclined in a manner so that the opening is oriented in a direction different from an extending direction of the conveying passage, with respect to the work section.

7. The vehicle according to claim 1, wherein
the vehicle is a riding lawn mower in which a seat for an occupant is disposed above the rear wheel, and
the opening of the battery holder is disposed so as to overlap the seat in a height direction.

8. The vehicle according to claim 1, further comprising an electrical component disposed below a rear portion of the battery holder and connected to the battery holder via a harness, wherein
a part of the lower portion of the battery holder is located forward of the electrical component.

9. The vehicle according to claim 1, further comprising an electrical component disposed below a rear portion of the battery holder and connected to the battery holder via a harness, wherein
a device-side connector configured to be electrically connected to the attachable and detachable battery is provided at a bottom portion of the battery holder, and
at least a part of the opening of the battery holder is located more forward than the device-side connector.

10. The vehicle according to claim 1, further comprising:
a covering portion configured to be openable and closable and to cover the opening; and
an electrical component disposed below a rear portion of the battery holder and connected to the battery holder via a harness, wherein
the battery holder includes a front-side accommodating portion configured to accommodate a first battery that is the attachable and detachable battery, and a rear-side accommodating portion configured to accommodate a second battery that is another attachable and detachable battery having a same shape as the first battery,
the front-side accommodating portion and the rear-side accommodating portion are inclined forward with respect to a vertical direction at a same inclination angle,
the rear-side accommodating portion is disposed more rearward than the front-side accommodating portion and above the electrical component, and the front-side accommodating portion is disposed forward of the electrical component, and
in a state in which the covering portion is closed, the covering portion covers the opening of each of the front-side accommodating portion and the rear-side accommodating portion, and an upper surface of the covering portion is inclined downward toward a front side.

11. The vehicle according to claim 2, further comprising an electrical component disposed below a rear portion of the battery holder and connected to the battery holder via a harness, wherein
the battery holder includes a front-side accommodating portion configured to accommodate a first battery that is the attachable and detachable battery, and a rear-side accommodating portion configured to accommodate a second battery that is another attachable and detachable battery having a same shape as the first battery,
the front-side accommodating portion and the rear-side accommodating portion are inclined forward with respect to a vertical direction at a same inclination angle,
the rear-side accommodating portion is disposed more rearward than the front-side accommodating portion and above the electrical component, and the front-side accommodating portion is disposed forward of the electrical component, and
in a state in which the covering portion is closed, the covering portion covers the opening of each of the front-side accommodating portion and the rear-side accommodating portion, and an upper surface of the covering portion is inclined downward toward a front side.
